(19) United States
(12) Patent Application Publication
(10) Pub. No.: US 2015/0154363 A1
(43) Pub. Date: Jun. 4, 2015

(54) METHOD, SYSTEM, AND APPARATUS FOR PRESCRIPTION MEDICINE ANALYSIS

(71) Applicant: Marlene MILES, Fredericksburg, VA (US)

(72) Inventor: Marlene MILES, Fredericksburg, VA (US)

(21) Appl. No.: 14/095,589

(22) Filed: Dec. 3, 2013

(51) Int. Cl. G06F 19/00

(52) U.S. Cl. CPC G06F 19/326; G06F 19/322

(57) ABSTRACT

A medical reference and information system using a computer system and software allowing for interactive access to a database containing information relevant to a physician treating a patient and the software is capable of analyzing lists of medications to determine drug interactions.

### BACKGROUND

Physicians prescribing medications to individuals must check for drug interactions before doing so. In the past this was done with a Physician's Desk Reference and a copy of that patient's medical records. Over time the reference became available online. However it still requires physicians to sit with a copy of the patient's records and look through the online reference.

Some patients such as the elderly or seriously ill, however, may routinely visit multiple doctors who each prescribe different medications or treatments. These doctors may rely on patients remembering and disclosing their medical history accurately. Often times a patient will forget about medications that they were put on and taken off of and not list it or they may forget the name of a new medication or even forget that they are taking that medication when visiting a doctor. As a result sometimes interacting medications are prescribed. Also changes are made to the entries of the medications themselves requiring re-evaluation by the attending physician, if the attending physician is aware of the change.

Pillboxes are used for aiding those taking medications to take the correct medication on the correct day at the correct time of day. However a great many people are nonetheless hospitalized each year for failing to properly take their medications despite their earnest efforts. As a result, various methods and devices have been created to assist people in the proper administration of medication. However there continues to be a large number of people requiring home nursing, assisted living, or hospitalization due to not understanding what to take and when, or forgetting to do so.

### SUMMARY

According to at least one exemplary embodiment, a medical reference system embodied in software installed on a computer system. The system allows for interactive access to a database containing information relevant to the medical treatment of a patient. The software may also be capable of analyzing lists of medications to determine drug interactions.

### BRIEF DESCRIPTION OF THE FIGURES

FIG. 1 is a representation of exemplary major system components of a medical reference and information system.

FIG. 2 is a representation of some exemplary publicly visible features of a medical reference and information system.

FIG. 3 is a representation of some exemplary features of an exemplary embodiment visible to a health care professional.

FIG. 4 is a representation of steps a feature may go through in a medical reference and information system.

FIG. 5 is a representation of some exemplary features of an exemplary embodiment visible to a patient.

FIG. 6 is a representation of steps a feature may go through in a medical reference and information system.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature(s), advantage(s) air mode(s) of operation(s).

Further, many of the embodiments described herein may be described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, “a computer configured to” perform the described action.

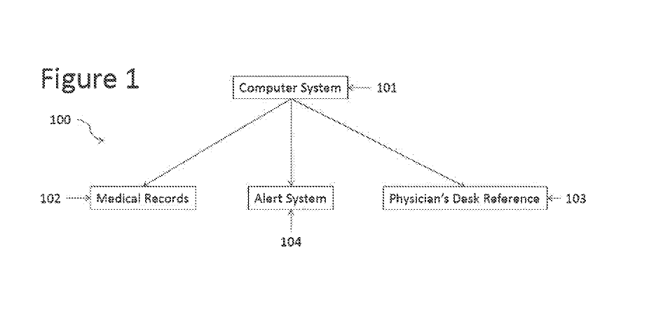

Generally referring to FIG. 1, an exemplary embodiment described herein may allow users to decrease health risks posed by incorrect prescription or by incorrect use. This may be through the use of software which may allow for the storage of medical records, searching and checking for drug interactions and alerting users of such interactions. The software and medical records may be stored on any storage medium known to a person skilled in the art and this storage medium may be a component of a computer system 101. The computer system 101 may be one or more computers which may be networked together. It may also be one or more computers connected with one or more other components or systems, some possible but not necessarily preferred examples being: external memory, telecommunication systems, medical apparatuses, or biological or chemical based sensor system(s), 3-D printers that use plastic, organic, or Chemical “inks”; or it may include any system known by a person of ordinary skill in the art. A computer may be a computing device which may have at least the following 4 components: a CPU, memory, a power supply, and circuitry connecting these but may consist of more or other components as known to persons skilled in the art. The software may also alert users of which medications to take and at what time, a physical description of a medication or a representation of a medication such as an image. The software may also alert users as to the amount of medication that should be taken at the time the alert is issued, or at the time a medication should be or normally is taken. The software may also allow users to notify the software of their having taken the medication, and the absence of such notification may act as a trigger to alert the user and/or other users of their not having taken the medication.

One exemplary embodiment described herein may provide a method and system for reducing mistakes made during the prescribing and taking of medicines. In one exemplary embodiment, as shown in FIG. 1, a website 100 stored on a computer system 101 can allow a user to store the medical records 102 of individuals, who may or may not be users themselves, on a computer system 101. The computer system 101 meanwhile may also store a digital version of a physician's desk reference 103, or any similar medical reference guide, book or database. A user may be a doctor, patient, healthcare provider, pharmacist, medical professional, a relative or caregiver of a patient, a hospital or any other entity. A user such as a doctor may be able to access both the desk reference 103 and the medical records 102 of the patients, who themselves may or may not be users.

Continuing with the current exemplary embodiment and still referring to FIG. 1, the desk reference 103 may be constantly or continuously updated as new information becomes available. The desk reference 103 may also contain information in one or more of the following mediums or formats: textual, visual, audio, audiovisual, 3-D printing file for models, 3-D printing file for printing medications, or any other medium used for the expression of information as may be used by a person with ordinary skill in the art. Following an update a computer system 101 may check to see if prescriptions whose medication entries have been updated interact with other medications a patient is taking. The computer system 101 may also check to see if certain over the counter medications should not be taken any longer or could continue to be taken but may cause side effects. The system may inform one or more users automatically if it detects such an interaction via an alert system 104. The alert system 104 may be able to contact patients via one or more of the following delivery systems or any other delivery system known to a person of ordinary skill in the art: SMS, MMS, telephone, e-mail, video call, fax, and so forth. A user may also be able to conduct independent searches for medical information or drug interactions without referencing a particular patient or a particular person's records. A user may also be able to select a patient and check to see what interactions would occur if a certain medication was administered before it was actually prescribed, administered, or taken.

Continuing with the current exemplary embodiment and still referring to FIG. 1, a user who may be a patient may be able to access their own medical records 102 and query the system to alert them, for example via the alert system 104, when certain medications should be taken. A user may also ask the alert system 104 to include a picture or other information about the medication and a patient may be able to update the website as to when and how much of a medication was taken. A patient may also be able to edit portions of their own records 102 or authorize or de-authorize access to the patient's records 102 by doctors, care takers, family or any other who may have a legitimate reason to have an account. A patient or other person with sufficient or appropriate access to their records 102 may also be able to receive an alert via the alert system 104 when a medication was not taken or when a medication was taken outside of the normal times or normal amounts.

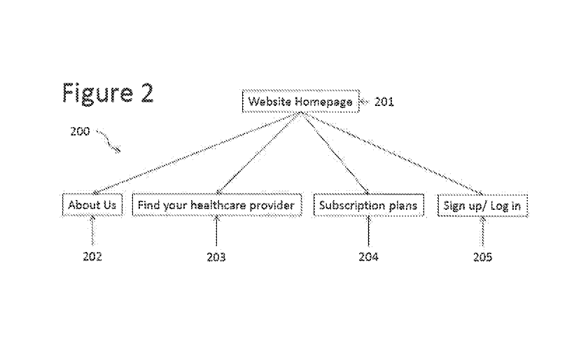

Referring now to FIG. 2, an exemplary embodiment of the software in the form of a centrally hosted website may be provided. The main website pages visible by a visitor 200 can be displayed in FIG. 2. A first page that may be seen in a typical example is the homepage 201. The homepage 201 may link to an About Us page 202 that would discuss the company's products, services, company history and its mission. The homepage 201 may also link to a Find your healthcare provider page 203 which may be used to find hospitals, clinics, doctors or other health care providers in your area and may also be used to search for particular doctors, hospitals, clinics, etc. There may also be a Subscription plans page 204 which can detail the features of each product and/or service and the cost of each. There may also be a sign up/log in page 205 so that new users can sign up and existing users could simply log in. As a user may both have a profile as a care provider and as a patient, the page may have a dropdown list with different categories of users and query existing users to select the category they are logging in as.

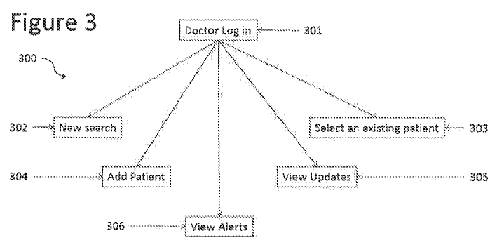

Continuing with this exemplary embodiment but now referring to FIG. 3, exemplary pages that may be visible to a doctor 300 are shown. After logging in, a viewer may have the doctor's log in page or home page 301, which may have features such as an icon for new drug interaction alerts 306. New drug interaction alerts 306 may notify the doctor if a patient has a new drug interaction they didn't previously have and which, by clicking on, the doctor may view in a list format. The new drug interaction may be the result of another physician prescribing a medication or as a result of the physicians' desk reference component (103 in FIG. 1) having been updated. There may also be a space listing when the latest update has taken place, which can include a summary of those entries that were updated and a link to view it in detail 305. From the home page 301 the doctor may also go to a screen where they may add a patient 304 or where they may select an existing patient 303. The doctor may also go to the search page 302, which can allow them to search for any information associated with the web pages or associated databases.

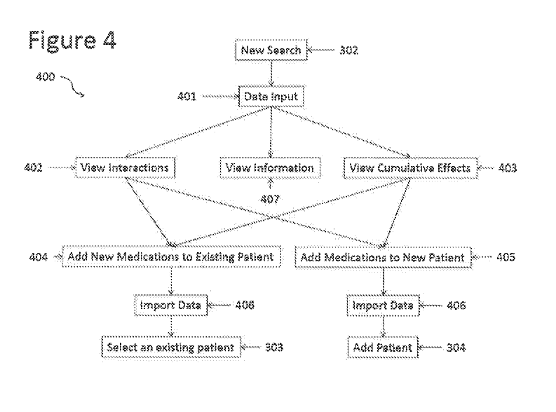

Now referring to exemplary FIG. 4, the doctor may have chosen to conduct a new search 302 that may bring them to a search page 400. Search page 400 can allow the doctor to enter a list of medications 401 and see their interactions 402 or effects 403. Alternatively, the doctor may search for a particular medication and see the information available on that medication 407. Once they have viewed the interactions 402 or the cumulative effects 403, the doctor may add new medications to an existing patient 404 or may add a record of medications prescribed to a new patient 405. These and other exemplary uses may allow for the importing of the data 406 from the search. The importing may be done through the use of a checkbox list or any other method of selecting individual elements of a displayed set known to a person of ordinary skill in the art. The doctor may then select an existing patient 303, for example if the doctor is adding new medication to an existing patient 404, or the doctor may add a patient 304 if the doctor is, for example, adding medications to a new patient 405.

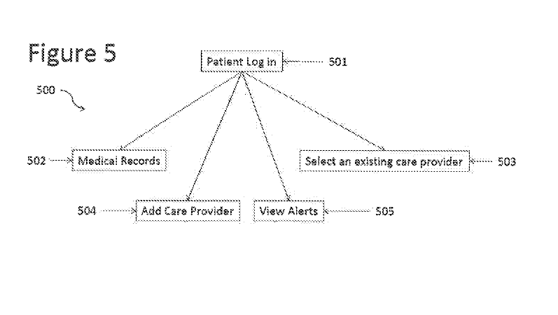

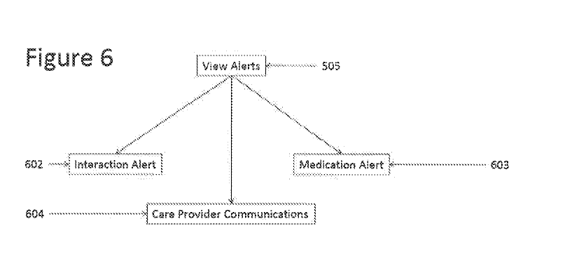

Now referring to exemplary FIG. 5 and continuing to refer to the current exemplary embodiment, the pages that may be visible after a subscribing patient logs in 500 may be shown. The logged in patient's homepage 501 may have a link that allows them to access their medical records 502 from which they may be able to view, copy, or print but not edit their records. There may also be a link to add a care provider 504 which may include a search function to find care providers already on the website and/or may include any method of establishing a social relationship between two individuals or institutions or an institution and an individual as may be known by a person with ordinary skill in the art. There may also be a link to select an existing care provider 503. Further, on that page, they may be able to view information on their existing care providers and communicate with them. There may also be a link to view alerts 505 which is discussed in further detail in FIG. 6.

Continuing with the current embodiment but now referring to exemplary FIG. 6, the view alerts page 505 and exemplary subsequent pages which may be accessed from it may be shown. The view alerts page 505 may inform the patient if a there is an interaction alert 602. An interaction alert 602 may be sent if a new drug interaction has been detected which may occur as the result of another medication having been prescribed or it may occur if the physicians' desk reference component (103 in FIG. 1) has been updated. There may also be a link for communications with a care provider 604 which may include textual, audio, visual or audiovisual communications or communications of any other type which may be a known by a person of ordinary skill in the art. There may also be a link to a medication alerts page 603 which can show alerts that are set up to notify the patient of when to take a medication and may allow the patient to indicate that they have taken the medication and in what quantity and when. The medication alert page 603 may also allow the patient to view records of how well they have been keeping up their schedule or may show other relevant statistics such as the average time they took certain medications. The medication alert page 603 may also provide a way to set up, edit, or delete alerts which may be subject to restrictions imposed by other users such as a doctor.

There are still many other potential exemplary embodiments which may utilize the items described herein. One exemplary embodiment could be to implement the system as a stand-alone program installed on a computer in a practitioner's office and that may be used solely by that practitioner. In this embodiment the practitioner, a doctor, may use the system for storing and managing patient records and as a physician's desk reference. Another embodiment could be a mobile application that could be used by field medics or doctors in remote locations. One exemplary situation for this embodiment would be a field hospital operated by doctors where the doctors are constantly changing but the patients may remain the same. In such a scenario the software may use a fingerprint, retina scan, DNA sample, or any other biometric identification system known by one skilled in the art to identify a patient rather than a name or username.

Yet another exemplary embodiment, which may be utilized at a small medical office, could allow for use of a computer system as a server and hosting a web portal which would restrict access to the staff of that office and their patients. Other scalable exemplary embodiments may be systems that are hosted by an insurance company, a hospital, or a government. These expanded embodiments may include pages and features such as insurance information, whether a brand name or generic drug is covered and how much the co-pay would be for a patient and may display alternative manufacturers and the co-pay for those. In an alternative exemplary embodiment where the system is implemented via a standalone business there may be various subscription or payment models for continued access. In such an embodiment there may be further features such as allowing for a search of health care providers to include quotes for selected services and allowing patients to rate these providers on their care.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A medical reference and information system comprising:
a computer system; and
software on the computer system that provides interactive access to a database containing medication information relevant to a physician treating a patient,
wherein the software analyzes lists of medications to determine appropriate or inappropriate drug interactions for a patient and provides an alert based on the analysis.

2. The medical reference and information system as in claim 1 wherein patient prescription records are stored.

3. The medical reference and information system as in claim 1, wherein the information stored in the database is represented by one or more of text, audio data, and visual data replica.

4. The medical reference and information system in claim 1 further comprising:
an interne connection;
a networked connection among a plurality of computers to access at least one of the software and the database through the interne.

5. The medical reference and information system as in claim 2 wherein the patient may access their own medical records.

6. The medical reference and information system as in claim 2 wherein the software alerts the patient to take their medications.

7. The medical reference and information system as in claim 2 wherein the software automatically performs a drug interaction analysis whenever a record of a new prescription is added.

8. The medical reference and information system as in claim 6 wherein the software alerts the patient regardless of whether the patient is currently using the system.

9. The medical reference and information system as in claim 7 wherein the software alerts the patient's doctors of the drug interaction.

10. The medical reference and information system as in claim 7 wherein the software alerts the patient of the drug interaction.
